(19) United States
(12) Patent Application Publication
(10) Pub. No.: US 2010/0205978 A1
(43) Pub. Date: Aug. 19, 2010

(54) Pipe Freezing

(76) Inventor: John Christopher Magrath, Blackpool, Lancashire (GB)

Correspondence Address: HODGSON RUSS LLP;THE GUARANTY BUILDING, 140 PEARL STREET, SUITE 100, BUFFALO, NY, 14202-4040, US

(21) Appl. No.: 12/679,647

(22) PCT Filed: Sep. 24, 2008
(86) PCT No.: PCT/GB08/50856

§ 371 Date: Apr. 27, 2010

(30) Foreign Application Priority Data
Sep. 26, 2007 (GB) 0718891.5

(51) Int. Cl. F25B 21/02; F16L 55/103; F28D 15/00

(52) U.S. Cl. 62/3.7; 165/104.19; 165/104.31

(57) ABSTRACT

Pipe freezing equipment (1) is described, including an electrically operated cooling unit. The cooling unit comprises Peltier heat pumps (12) in thermal contact with the pipe, and a fluid medium used to remove heat from the Peltier heat pumps (12).

### FIELD OF THE INVENTION

The present invention relates to pipe freezing, in particular but not exclusively to water pipe freezing.

### BACKGROUND TO THE INVENTION

Methods and apparatus for isolating a section of pipe to make repairs are described in GB 2 206 940. By freezing fluid in a pipe it is possible to isolate a section of the pipe, for example to effect repairs to the pipe.

### SUMMARY OF THE INVENTION

In a first aspect, the present invention provides an electrically operated piece of equipment suitable for freezing fluid in a pipe, the apparatus comprising:
a freezing head including a solid state cooling device, and
a fluid medium arranged in use to carry heat from the solid state cooling device for dispersal of heat at a heat dispersal unit located away from the freezing head, the fluid medium located in a closed circulatory loop for subsequent return to the freezing head from the heat dispersal unit.

Suitably, the sold state cooling device comprises a Peltier heat pump device.

Suitably, the dispersal unit comprises a forced air radiator. Suitably, a fluid medium pump is provided to to circulate the fluid medium. Suitably, the fluid medium comprises a mixture of glycol and water.

Suitably, the electrically operated piece of equipment further comprises a coolant chiller provided to lower the temperature of the fluid medium below the ambient temperature in which the heat dispersal unit operates. Suitably, the coolant chiller is located away from the freezing head. Suitably, the coolant chiller comprises a Peltier heat pump device and/or a vapour phase refrigerator.

Suitably, the electrically operated piece of equipment comprises a heat removal tank containing fluid medium, the heat removal tank in direct physical contact with the solid state cooling device.

Suitably, the electrically operated piece of equipment comprises a freezing head including pivotally connected jaw portions arrangeable in use to clamp around a portion of a pipe to be frozen. Suitably, the jaw portions pivot about point, and are biased towards one another. Suitably, the jaw portions are biased by a spring. Suitably, the jaw portions are coupled to handles. Suitably, the electrically operated piece of equipment comprises a block or blocks located in the freezing head. Suitably the blocks are located in the jaw portions.

Suitably the blocks in use contact the pipe to be frozen, providing a heat conduction path from the pipe to solid state device. The or blocks suitably comprise complementary portions of a cylindrical bore, said bore for receiving the pipe in use. The electrically operated equipment is suitably provided in a set with a range of interchangeable blocks having different sized bores, to allow the equipment to be used with pipes of a range of sizes.

Suitably, the electrically operated piece of equipment further comprises a protection shim that lies between the solid state cooling device and a portion of the freezing head that in use contacts a pipe to be frozen.

Suitably, the electrically operated piece of equipment, further comprises a sealing gasket in the freezing head, the sealing gasket used to cover and seal a leak in a pipe to be frozen in cases when the equipment used to freeze a portion of a pipe that has a leak.

Suitably, the electrically operated piece of equipment further comprises one or more temperature sensors in the freezing head. Suitably, temperature information from the sensors is arranged to trigger an indicator confirming a sufficiently low predetermined temperature level has been reached. Suitably, temperature information from the sensors is arranged to trigger an indicator confirming that water within the pipe is sufficiently frozen to allow the pipe to be safely uncoupled or cut, according to predetermined control logic relating sensed temperature to time. Suitably, temperature information from the sensors is arranged to trigger an indicator confirming the sensed temperature has been held at a sufficiently low predetermined level for a predetermined time period.

Suitably, the electrically operated piece of equipment is further arranged to thaw a frozen pipe by using the solid state device to supply heat to the pipe. Suitably, the electrically operated piece of equipment comprises a switching circuit for controlling a change from freezing to thawing, such that a cooling supply voltage to the solid state element is gradually reduced before the polarity is reversed to commence a heating operation.

According to the present invention there is provided an apparatus and method as set forth in the appended claims. Other features of the invention will be apparent from the dependent claims, and the description which follows.

For a better understanding of the invention, and to show how embodiments of the same may be carried into effect, reference will now be made, by way of example, to the accompanying diagrammatic drawings in which:

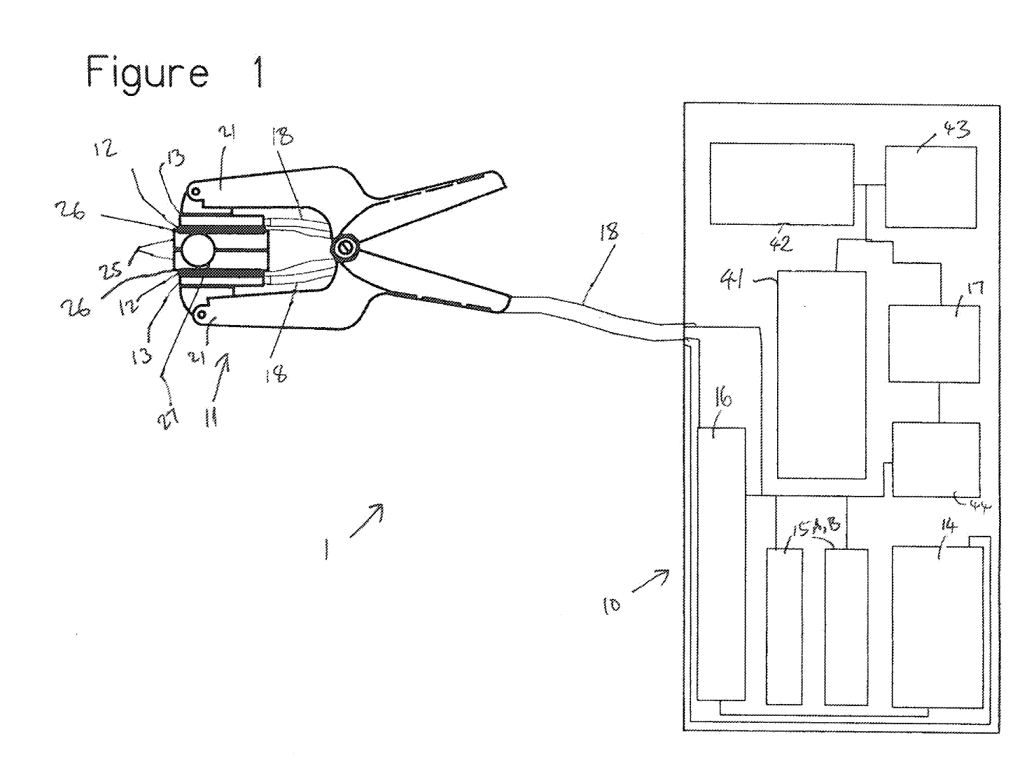

FIG. 1 shows an electrically operated piece of equipment suitable for freezing fluid in a pipe, according to an example embodiment of the present invention;

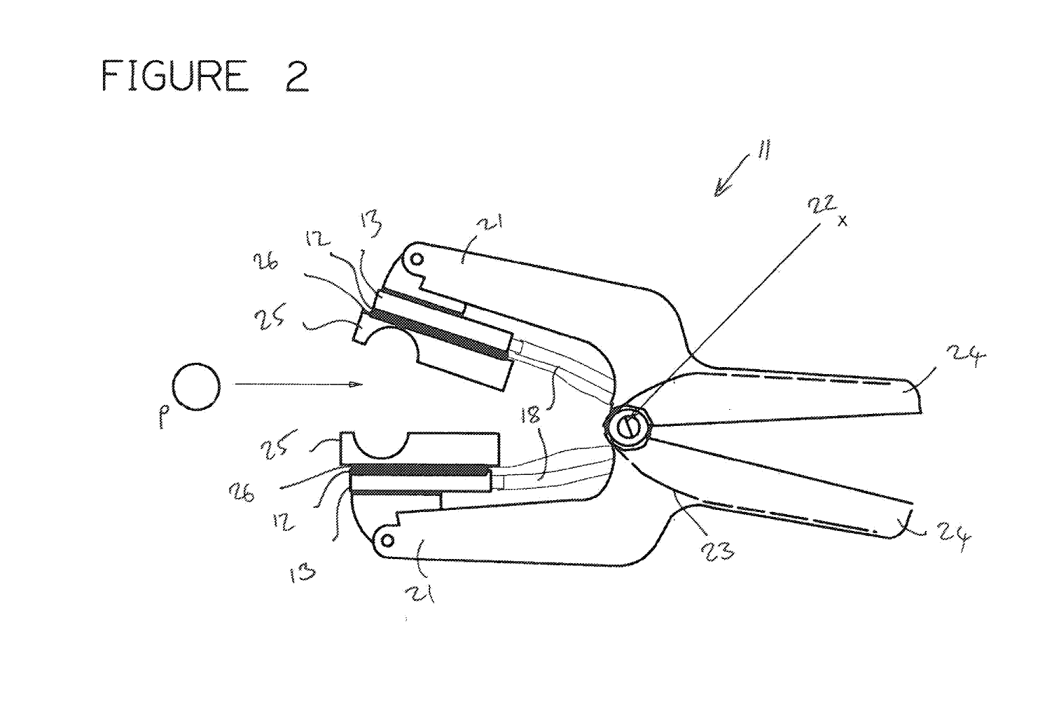

FIG. 2 shows the freezing head portion of the equipment shown in FIG. 1;

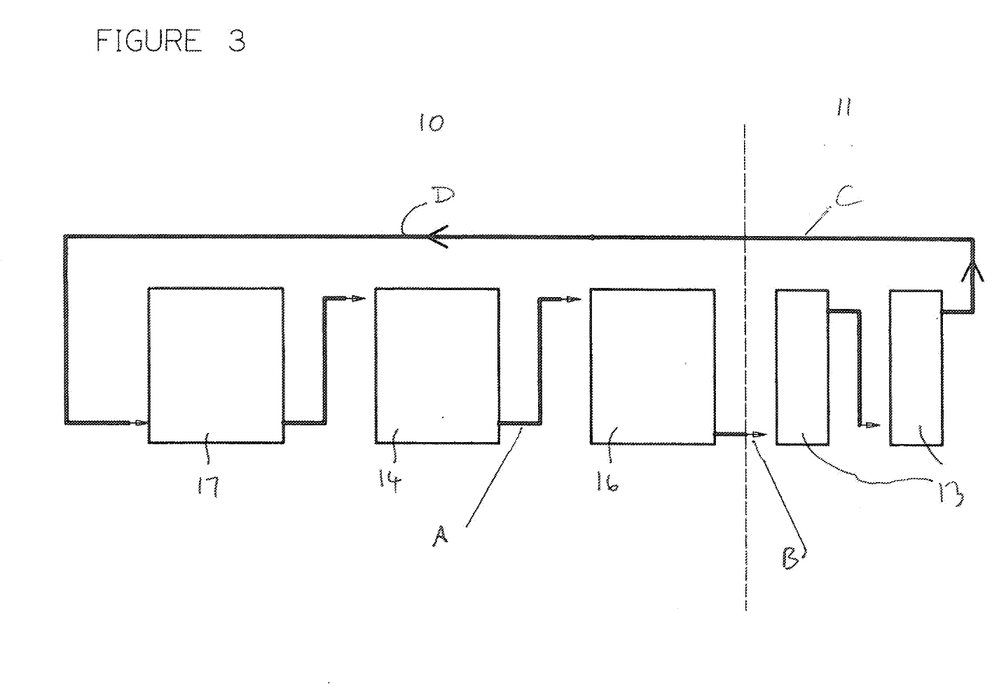

FIG. 3 is a schematic illustration of the coolant fluid medium system of the equipment shown in FIG. 1; and

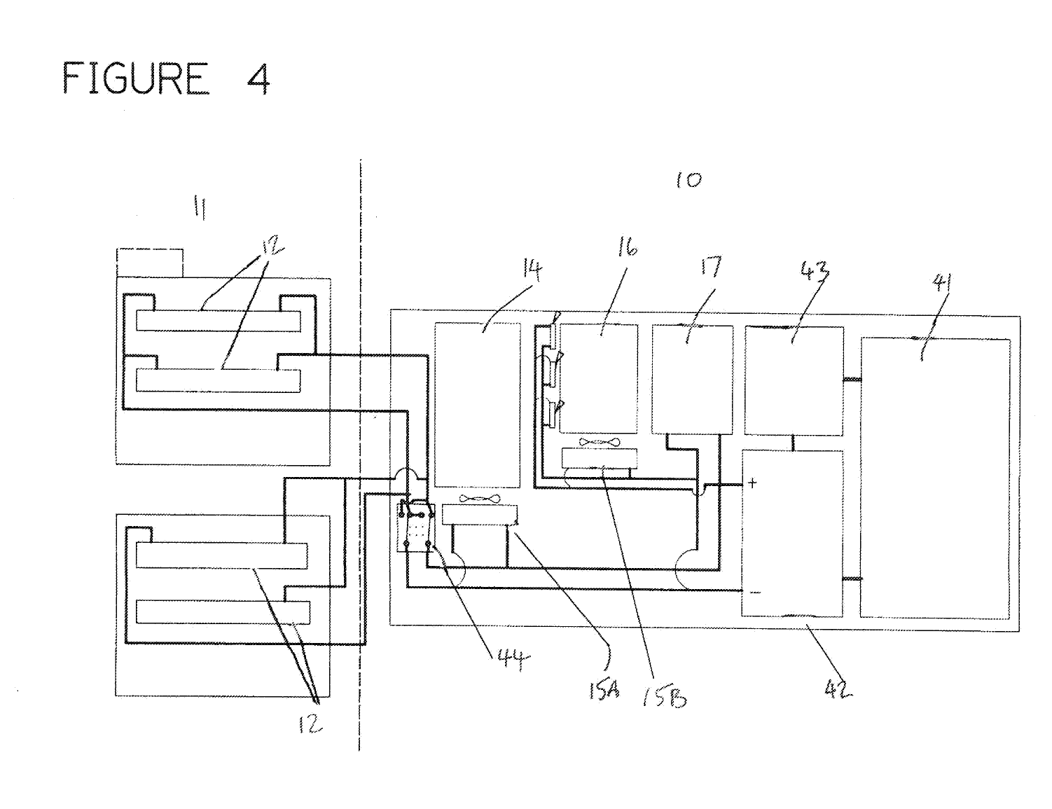

FIG. 4 is a schematic illustration of the electrical system of the equipment shown in FIG. 1.

Referring now to FIG. 1 there is shown an electrically operated piece of equipment 1 suitable for freezing fluid in a pipe, according to an example embodiment of the present invention. The fluid is suitably a liquid, in particular water. The equipment 1 comprises a freezing head 11 and a main body 10. The freezing head 11 includes a solid state cooling device—in this example Peltier heat pump devices 12 fitted in the freezing head 11. The Peltier heat pump devices 12 comprise thin wafers of semiconductor material, with one side of a p-n junction in the wafer cooled and the side other heated when an electrical potential is provided across the junction. The Peltier heat pump devices 12 may comprise multi-layered devices comprising more than one p-n junction in a stacked arrangement.

The amount of cooling provided by a Peltier heat pump device is dependent on the amount of heat which is removed from the hot side of the device. In use, heat is removed from the hot side of the Peltier heat pump devices 12 using a coolant fluid medium circulated to and within heat removal tanks 13. Each of the heat removal tanks 13 is in direct physical contact with one of the Peltier heat pump devices 12 to ensure effective thermal conduction there-between. The fluid medium is circulated to the heat removal tanks 13 as part of a closed circulatory loop.

When the equipment 1 is switched on, the Peltier heat pump devices 12 are energised and cooling begins. In the embodiment of FIG. 1, a 12 volt direct current is for example supplied to the Peltier heat pump devices 12. Heat is removed from the hot side of the Peltier heat pump devices 12 by passing into the heat removal tanks 13. The heat removal tanks 13 are filled with fluid medium that is in use pumped round a circuit from the freezing head 11 to a heat dispersal unit in the form of a forced air radiator 14. A fluid medium pump 17 is provided to circulate the fluid medium, and a flexible hose 18 is provided coupling the heat removal tanks 13 to the pump and other components of the main body 10. The forced air radiator 14 is provided with at least one electrically operated fan 15A to cool the radiator 14, thereby dispersing heat from the fluid medium to the atmosphere. In this example embodiment the fluid medium comprises a mixture of glycol and water.

The fluid medium passes from the radiator into a coolant chiller 16. The coolant chiller 16 is provided to lower the temperature of the fluid medium below the ambient temperature in which the forced air radiator 14 operates. On exiting the coolant chiller 16, the fluid medium passes to the heat removal tanks 13 to absorb heat from the hot sides of the Peltier heat pump devices 12. The use of a coolant chiller 16 reduces the cooling load on the Peltier heat pump devices 12, which are therefore better able to achieve freezing temperatures when the ambient temperature is relatively high. In this way the freezing head 11 is easily able to freeze water in pipes by achieving Peltier heat pump device cold temperatures of well below zero degrees Celsius, e.g. minus five degrees Celsius when the ambient temperature is for example 30 degrees Celsius or higher. The coolant chiller 16 may be provided using a vapour cycle refrigerator, or a further Peltier heat pump device may be used in addition or as an alternative to a vapour cycle refrigerator. The coolant chiller 16 suitably includes a fan 15B to aid heat dispersal. FIG. 3 shows a schematic illustration of the coolant system of the equipment shown in FIG. 1. At point A the temperature of the fluid medium is close to the ambient air temperature. At point B the temperature of the fluid medium is below the ambient air temperature. At point C heat has been removed from the Peltier heat pump devices 12 and at point D warm fluid medium is returned from the freezing head 11 to the fluid medium pump 17.

Referring now to FIG. 2 there is shown the freezing head 11, including pivotally connected jaw portions 21 that in use clamp around a portion of a pipe P to be frozen. The jaw portions pivot about point 22, and are biased towards one another by a spring 23. The jaw portions 21 are coupled to handles 24 that when brought together by hand pressure applied by a user separate the jaw portions 21 against the bias of the spring 23. With the jaw portions 21 opened the freezing head 11 is placed around the pipe P to be frozen. When hand pressure is released the freezing head 11 is held firmly around the pipe P.

The jaw portions 21 each carry one of the Peltier heat pump devices 12. The jaw portions 21 each include a Peltier protection shim 26. The Peltier protection shims 26 are provided to form a physical protective layer to protect the Peltier heat pump devices 12 from damage caused by knocks, impact etc. The Peltier protection shims 26 are suitably of high thermal conductivity, and lie between the Peltier heat pump devices 12 and the portions of the freezing head 11 that in use contact the pipe P, i.e. between the Peltier heat pump devices 12 and blocks 25 located in the jaw portions 21.

The blocks 25 are metallic and in use contact the pipe P to be frozen, providing a heat conduction path from the pipe P to the Peltier heat pump devices 12 via the Peltier protection shims 26. The blocks 25 suitably comprise complementary portions of a cylindrical bore, said bore for receiving the pipe P in use. The equipment 1 is suitably provided in a set with a range of interchangeable blocks 25 having different sized bores, to allow the equipment to be used with pipes of a range of sizes. Typically domestic pipes are supplied with outer diameters of 8 mm, 10 mm, 15 mm and 22 mm, so corresponding blocks 25 are supplied.

One of both of the blocks 25 in use may comprise a sealing gasket 27, suitably of a rubber material. The sealing gasket 27 is suitably provided at an end portion of a block 25, and is used to cover and seal a leak in the pipe P in cases when the equipment 1 is to be used to freeze a portion of a pipe that has a leak. The sealing gasket prevents the pipe from leaking while freezing takes place.

One or more temperature sensors may be provided in the freezing head 11. For example, thermistors may be provided in each jaw portion 21. The temperature sensors are coupled to circuitry in the main body 10. The temperature information from the sensors is used to trigger an indicator confirming that water within the pipe P is sufficiently frozen to allow the pipe to be safely uncoupled or cut. In one embodiment the indicator is triggered when the sensed temperature has reached a sufficiently low predetermined level. In another embodiment the indicator is triggered when the sensed temperature has been held at a sufficiently low predetermined level for a predetermined time period. For example, holding the temperature of at the jaw portions 21 at minus five degrees Celsius has been found to freeze water in a standard 15 mm copper pipe after a period of approximately 6 minutes. Narrower 8-10 mm copper pipes are typically frozen after being held at minus five degrees Celsius for 4 minutes, whereas wider 22 mm copper pipes are typically frozen after being held at minus five degrees for approximately 9 minutes. The indicator is arranged to generate a sound and/or to provide a visual indication.

To thaw a frozen pipe the polarity of the voltage supplied to the Peltier heat pump devices 12 is reversed. Typically, the cooling supply voltage is gradually reduced before the polarity is reversed. In this embodiment with a 12V cooling voltage, a heating voltage of 5V is suitably applied to the Peltier heat pump devices 12. A switching circuit 44 for controlling the change over from freezing to thawing is provided.

The embodiments shown are provided with a power supply 41 for providing a 13.8V voltage to the electrical components of the main unit. The power supply 41 is a transformer to step down a mains supply voltage input to equipment 1. The equipment 1 also comprises a battery 42. The battery 42 is rechargeable, and draws power from the power supply 41 via a charging circuit 43 when the equipment 1 is coupled to a mains electrical supply. The battery 42 allows the equipment 1 to function without being connected to a mains electrical supply, which is useful if no mains supply is available or if the equipment 1 is to be used in wet conditions where an electrical shock risk would be posed by use of a mains supply.

The embodiments described herein offer convenient freezing of pipes, that is, solidification of a fluid medium, especially a liquid medium contained within a pipe. The example embodiments of equipment as described are portable, safe and easy to use, and can be operated successfully in relatively high ambient temperatures.

Although a two-jawed device has been described, it is to be understood that other embodiments may include only a single cooling jaw.

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An electrically operated piece of equipment suitable for freezing fluid in a pipe, the apparatus comprising:
a freezing head including a solid state cooling device, and
a fluid medium arranged in use to carry heat from the solid state cooling device for dispersal of heat at a heat dispersal unit located away from the freezing head, the fluid medium located in a closed circulatory loop for subsequent return to the freezing head from the heat dispersal unit.

2. The electrically operated piece of equipment of claim 1, wherein the dispersal unit comprises a forced air radiator.

3. The electrically operated piece of equipment of claim 1, comprising fluid medium pump to circulate the fluid medium.

4. The electrically operated piece of equipment of claim 1, wherein the fluid medium comprises a mixture of glycol and water.

5. The electrically operated piece of equipment of claim 1, further comprising a coolant chiller is provided to lower the temperature of the fluid medium below the ambient temperature in which the heat dispersal unit operates.

6. The electrically operated piece of equipment of claim 5, wherein the coolant chiller is located away from the freezing head.

7. The electrically operated piece of equipment of claim 5, wherein the coolant chiller comprises a Peltier heat pump device.

8. The electrically operated piece of equipment of claim 1 comprising a heat removal tank containing the fluid medium, the heat removal tank in direct physical contact with the solid state cooling device.

9. The electrically operated piece of equipment of claim 1, further comprising a protection shim that lies between the solid state cooling device and a portion of the freezing head that in use contacts a pipe to be frozen.

10. The electrically operated piece of equipment of any preceding claim 1, further comprising a sealing gasket in the freezing head, the sealing gasket used to cover and seal a leak in a pipe to be frozen.

11. The electrically operated piece of equipment of claim 1, further comprising one or more temperature sensors in the freezing head.

12. The electrically operated piece of equipment of claim 11, wherein temperature information from the sensors is arranged to trigger an indicator confirming a sufficiently low predetermined temperature level has been reached.

13. The electrically operated piece of equipment of claim 11, wherein temperature information from the sensors is arranged to trigger an indicator confirming that water within the pipe is sufficiently frozen to allow the pipe to be safely uncoupled or cut, according to predetermined control logic relating sensed temperature to time.

14. The electrically operated piece of equipment of claim 12, wherein temperature information from the sensors is arranged to trigger an indicator confirming the sensed temperature has been held at a sufficiently low predetermined level for a predetermined time period.

15. The electrically operated piece of equipment of claim 1, arranged to thaw a frozen pipe by using the solid state device to supply heat to the pipe.

16. The electrically operated piece of equipment of claim 15, comprising a switching circuit for controlling a change from freezing to thawing, such that a cooling supply voltage to the solid state element is gradually reduced before the polarity is reversed to commence a heating operation.
